(19) United States
(12) Patent Application Publication
(10) Pub. No.: US 2012/0103828 A1
(43) Pub. Date: May 3, 2012

(54) ELECTRODE FOR ELECTROLYTIC CHLORINE PRODUCTION

(75) Inventors: Andreas Bulan, Langenfeld (DE); Jürgen Kintrup, Leverkusen (DE); Rainer Weber, Odenthal (DE); Ruiyong Chen, Saarbrucken (DE); Vinh Trieu, Saarbrucken (DE); Harald Natter, Saarbrucken (DE); Rolf Hempelmann, St. Ingbert (DE)

(73) Assignee: Bayer MaterialScience AG, Leverkusen (DE)

(21) Appl. No.: 13/280,564

(22) Filed: Oct. 25, 2011

(30) Foreign Application Priority Data
Oct. 28, 2010 (DE) 102010043085.4

(51) Int. Cl. C25B 11/06; H01M 4/88; C25B 1/26; C25B 9/00; C25B 11/08

(52) U.S. Cl. 205/625; 204/242; 204/290.03; 204/290.12; 204/290.14; 502/101

(57) ABSTRACT

The present invention relates to an electrode comprising an electrically conductive substrate and a catalytically active layer, wherein the catalytically active layer is based on two catalytically active components and comprises iridium, ruthenium or titanium as metal oxide or mixed oxide or mixtures of the oxides, wherein the total content of ruthenium and/or iridium based on the sum of the elements iridium, ruthenium and titanium is at least 10 mol %, and wherein the electrode comprises at least one oxidic base layer which is applied to the electrically conductive substrate and is impermeable to aqueous electrolytes comprising NaCl and/or NaOH and/or HCl.

### CROSS REFERENCE TO RELATED APPLICATIONS

This application claims benefit to German Patent Application No. 10 2010 043 085.4, filed Oct. 28, 2010, which is incorporated herein by reference in its entirety for all useful purposes.

### BACKGROUND

The invention proceeds from known electrodes containing noble metal catalysts for the electrolytic preparation of chlorine. The field of the invention relates to a process for producing a catalyst coating for electrodes for improved chlorine recovery, which coating is applied to an electrically conductive support material, and novel electrodes which can be obtained from the process. The coating consists, in particular, of a dense and crack-free base layer and a highly porous covering layer. Base and covering layers consist, for example, of mixed oxides based on Ti, Ru or Ir and one or more doping elements from the transition metal series. Both layers are applied to an electrically conductive support by means of a modified sol-gel process with subsequent thermal treatment.

Industrial chlorine production is carried out by means of electrolytic decomposition of sodium chloride or hydrochloric acid solutions. As an alternative to the amalgam process employed earlier, the diaphragm process and the ion-exchange membrane process are employed exclusively today. The greatest cost factor in chlorine production is electric energy. The energy consumption for producing a tonne of chlorine is typically about 2500 kWh in chloralkali electrolysis (membrane process). The other processes mentioned are still far more energy intensive. To reduce the costs in chlorine production, ohmic resistances which occur at membranes, in the electrolyte and at the electrodes are greatly reduced by design of the cells. To reduce the energy consumption further, catalysts which reduce the decomposition potential in the electrolysis are applied to the electrodes. The overvoltage for charge transfer at the anode in the evolution of chlorine depends greatly on the material, on the morphology of the surface and on the method by which the catalyst is produced. Modern anodes are usually based on expanded metal plates made of titanium, nickel, tantalum or zirconium as supports. Oxides or mixtures of oxides of elements of the platinum group are usually applied to the surface of the supports. Here, it has been found that ruthenium dioxide (RuO₂) is a stable catalyst for the evolution of chlorine. A critical disadvantage of RuO₂ as electrocatalytically active material is the poor long-term stability of known electrode coatings produced therefrom as a result of dissolution of the catalyst coating during the electrolysis. This results in a continual decrease in the catalytic activity of the anode during use. To stabilize the active ruthenium component, a mixture of, for example, RuO₂ and titanium dioxide is used in chloralkali electrolysis. Due to them having the same crystal structure, RuO₂ and TiO₂ form a solid solution which prevents chemical attack and the removal of RuO₂. This effect is described in the U.S. Pat. No. 3,632,498. The authors of U.S. Pat. No. 3,562,008 find that an anode coated with RuO₂-TiO₂ and having a content of 50 mol % of ruthenium displays a reduced cell voltage for the evolution of chlorine and an improved stability compared to an uncoated Pt anode.

The influence of the use of various materials and coating morphologies on the electrocatalytic effectiveness in the evolution of chlorine is described in various documents, but the effects can not always be completely separated from one another.

DE 40 32 417 A1 describes a RuO₂-TiO₂ coating having a gradient structure. Here, the ruthenium content in the layer decreased from 40 to 20 mol % in the direction of the anode surface. The anodic oxidation should therefore take place virtually exclusively at the interface to the electrolyte and thus avoid volume erosion which reduces the operating life.

EP 0 867 527 A1 describes the preparation of a ternary oxide mixture of TiO₂, RuO₂ and IrO₂ for various electrode applications, having a gradient of the ratio of the metal oxides of the noble metals to the oxide of the valve metal which increases from 13 to 100 mol % from the first layer applied in the direction of the surface to the outermost applied layer. Since the uppermost layer consists of only noble metal oxides, the abovementioned disadvantages of pure noble metal oxides, in particular the unsatisfactory long-term stability, are to be expected, at least in the case of chlorine production.

An improved performance in chlorine evolution is achieved in U.S. Pat. No. 4,517,068 by a combination of TiO₂-RuO₂ with palladium oxide.

T.A.F. Lassali et al. (Electrochimica Acta 39, 1545 (1994)) find a drastic increase in the electrochemically active area and thus an increase in the electrocatalytic activity when TiO₂ is replaced by PtOₓ. The authors describe a layer composition of Ru_{0.3}PtₓTi_{0.7-x}O₂. The catalyst layer is produced by thermal decomposition of metal salts (e.g. metal halides). A disadvantage is the high cost of obtaining the noble metal platinum. Furthermore, chemical instability of Pt-containing coatings (bleaching of platinum in the form of hexachloroplatinate solutions) can reduce the life of the coating and thus make industrial use difficult.

WO 2006/028443 A1 likewise describes the production of palladium-containing catalyst mixed oxide layers, which apart from Ru and iridium oxides can also contain antimony, tin and tantalum as doping elements, by thermal decomposition of various metal salts. Here, a reduction in the overvoltage for chlorine evolution by 100 mV compared to undoped layers was able to be obtained.

Furthermore, thermal decomposition processes for producing doped and undoped catalyst layers which are applied as a single layer to a metallic substrate are known from the following documents: J. Electrochem. Soc. 129 1689 (1982), Electrochimica Acta 42, 3525 (1997), J. Alloys and Compounds 261, 176 (1997).

S. Trasatti, Electrochim. Acta, 36, 225 (1991) and G.R.P. Malpass et al, Electrochim. Acta, 52, 936 (2006) describe the typical morphologies of the electrocatalytically active oxide coatings produced by the conventional thermal decomposition method. Defects in the oxide coating, e.g. cracks, pores, holes and grain barriers, offer the electrolyte highly accessible internal catalytically active sites and therefore increase the apparent electrocatalytic activity for the chlorine formation reaction.

On the other hand, the electrolytes can penetrate through the defects in the electrocatalytically active oxide layer as far as the titanium substrate and attack the latter, which brings about detachment of the electrocatalytically active oxide layer and also promotes the growth of an electrically insulating titanium oxide intermediate layer between the metallic support material and the active oxide layer, which subsequently results in increased ohmic losses and deactivation of the anode, as described by L. M. Da Silva, et al., J. Electroanal. Chem. 532, 141 (2002).

Different strategies have been developed for avoiding the passivation of the support material caused by contact with electrolytes used in the electrolysis, for example aqueous solutions of sodium chloride or hydrogen chloride in chlorine production.

As described in EP 0046449 A1, very many coating application/sintering cycles are usually employed to increase the layer thickness and lengthen the life of the coating. The cracks and pores in the last coating layer applied are at least partly filled with the coating solution in the next coating application. The number of internal defects is reduced with each further application cycle.

A disadvantage of this method is the large number of application cycles required, with a high consumption of material. A further disadvantage is that, owing to the small number of defects, the electrochemically active area and thus the electrocatalytic activity decreases, associated with an increased consumption of electric energy in the electrolysis. Furthermore, the electrical conductivity which is low compared to the support material can lead, at excessively great layer thicknesses, to increased ohmic losses and to increased cell voltages in the electrolysis.

To avoid the formation of titanium oxide intermediate layers which have no or only poor electrical conductivity, the concept of an intermediate layer located on the valve metal support and underneath the electrocatalytically active outer layer has been developed. Such an intermediate layer can also be described by the terms underlayer, barrier layer, protective layer or base layer and the outer layer can also be referred to as covering layer.

One possible way of obtaining a base layer is application of metallic platinum as described, for example, for the cathodic corrosion protection of titanium in Hayfield, Precious Metal Review 27(1) 1983_{—}2-8. Disadvantages for use in chlorine production are, in particular, the chemical instability (formation of hexachloroplatinate solutions) and the high cost of obtaining the noble metal platinum.

In other documents, the production of electrochemically more stable noble metal-free intermediate layers by thermal decomposition, plasma beam or plasma spraying is described. In U.S. Pat. No. 3,882,002, antimony-doped tin oxide is applied as protective layer to the valve metal substrate, with an outer noble metal layer. U.S. Pat. No. 3,950,240 describes an anode having niobium-doped tin oxide as intermediate layer and a covering layer composed of ruthenium oxide. U.S. Pat. No. 7,211,177 B2 describes an intermediate layer composed of titanium carbide or titanium boride for the electrolysis of hydrochloric acid.

Disadvantages of all intermediate layers mentioned are nonoptimal adhesion between the protective layer and the support material and between the intermediate layer and the electrocatalytically active covering layer.

Increasing the surface area of ruthenium oxide-based electrode layers was examined by Y. Takasu (Electrochemica Acta 45, 4135 (2000)), with five different methods, viz. (1) the addition of sodium carbonate to an alcoholic dipping solution for dipcoated RuO₂-Ti electrodes, (2) the production of RuO₂-MOₓ (M: doping metal) by dip coating, (3) the production of RuO₂-ROₓ (R: rare earth element) layers to titanium electrodes by dip coating followed by chemical dissolution of the rare earth oxide by means of acid, (4) the addition of ammonium hydrogencarbonate salt as catalyst in the sol-gel process to produce ultrafine RuO₂ particles and (5) conversion of RuO₂ into an HₓRuO_{y} layer structure, being used.

The surface structure was characterized electrochemically by determining the cyclovoltammetric charge on the electrodes produced. In the case of mixed oxide electrodes of the RuO₂-TiO₂ type, the cyclovoltammetric charge is 12 mC/cm², and for RuO₂-SnO₂ is 13 mC/cm². The highest cyclovoltammetric charges were obtained for the systems RuO₂-VOₓ(162 mC/cm²), RuO₂-MoO₃ (120 mC/cm²), RuO₂-CaO (130 mC/cm²), but as a rule no homogeneously mixed oxides but instead a heterogeneous mixture of different oxides are obtained in this way, with the disadvantages mentioned above for pure RuO₂ as catalyst for chlorine production. These disadvantages are also displayed by coating compositions obtained by the abovementioned methods (1), (3), (4) and (5). Use examples for the use of coatings for chlorine production are not described.

The processes disclosed hitherto make it possible to produce catalyst layers having a typical noble metal content in the range from 20 to 50 mol %. Since noble metal salts and the noble metal itself have to be obtained in a complicated manner in many process steps, the technical outlay for use in large-scale industrial processes is very high and limits utilization.

It has been able to be shown that a reduction in the ruthenium content can be achieved in the simple RuO₂-TiO₂ system by partial replacement of RuO₂ by transition metal oxides (Ce, Nb, Sn, V, Cr, Mn, Co, Sb, Zr, Mo, W, Ta). In addition, an improvement of the activity, selectivity and stability can be achieved by means of a synergistic effect by combing various transition metal oxides. Experimental data are described by S. V. Evdokimov et al. in Russian Journal of Electrochemistry 38, 657 (2002). Addition of 10 mol % of CrNbO₄ enable the RuO₂ content in the standard system RuO₂-TiO₂ to be reduced from 70 to 30 mol %. The electrocatalytic activity here is comparable to the standard system.

U.S. Pat. No. 3,776,834 states that the overvoltage for chlorine evolution using the system 33.3 mol % of RuO₂-66.7 mol % of TiO₂ can be reduced by 40 mV as a result of the use of the ternary system 19 mol % of RuO₂, 13 mol % of SnO₂, 68 mol % of TiO₂ in which the RuO₂ has been partly replaced by SnO₂. The use of doping elements also enables the chemical corrosion resistance to be increased. U.S. Pat. No. 4,039,409 and U.S. Pat. No. 3,948,751 describe the production of doped catalyst layers by mixing the salt of a doping element with thermally unstable Ru salts and applying the mixture directly to titanium in an application process. The final thermal treatment forms a doped catalyst layer. The composition of the layer can be controlled by means of the amount of the salt of the doping element. This technique is comprehensively described in Y. E. Roginskaya et al., Electrochimica Acta 40, 817 (1995). Disadvantages are the resulting very inhomogeneous microstructures of a coating composed of a plurality of components. These observations are also described in U.S. Pat. No. 4,668,531. At temperatures above 500° C., a dense and electrically insulating TiO₂ layer is formed between the catalyst layer and the support. Such intermediate layers impair the electrode performance. This relationship is described in WO 2008/046784 A1.

It has been found that the sol-gel technique represents a very good alternative to the thermal decomposition of noble metal salts. Here, mixed oxides can be prepared in a targeted manner by controlled hydrolysis and condensation of precursor compounds.

According to CN 1900368 A1, dopings of Sn oxide, Ir oxide, Mn oxide and cobalt oxide are introduced into an anode coating consisting of RuO₂ and a high content of CeO₂ by means of a sol-gel process. The authors observed an increased activity for chlorine evolution for the doped ternary or quaternary coatings (with 45 mol % of RuO₂) compared to the binary RuO₂/CeO₂ system. As stated in V. V. Panic et al., Colloids and Surfaces A 157, 269 (1999), catalyst coatings produced by means of the sol-gel technique display increased stability and a longer life compared to conventionally produced layers (thermal salt decomposition). Y. Zeng et al., Ceramics International 33, 1087 (2007) also report that RuO₂-IrO₂-TiO₂ catalyst layers produced by means of the sol-gel technique display increased activity due to the reduced particle size.

However, the known sol-gel technique displays a particular disadvantage in respect of the solubility of inorganic salts and alkoxides in organic solvents. To obtain a sufficient solubility, modification with strong acids and treatment with ultrasound are necessary. These procedures drastically lengthen the production process. Some of the coating solutions produced in this way have a low stability since the less soluble constituents reprecipitate prematurely (particularly at high concentrations). These solutions cannot be stored and in the extreme case lead to inhomogeneous coatings on the electrodes.

Novel coatings and associated preparation processes which do not display the above-described disadvantages of the coatings, viz. a high noble metal content, unsatisfactory selectivity and stability and a lack of electrical conductivity, and of the production process were sought.

### Brief Description of Preferred Embodiments

For the reasons described, it was an object of the present invention to develop a simple and versatile process for producing a catalyst layer for electrodes, in particular for anodes for chlorine production, on the basis of the sol-gel process while avoiding the abovementioned disadvantages. This layer consists of an electrocatalytically active component and a stabilizer which should ensure long-term stability. Furthermore, the anodes should display a decrease in the chlorine overvoltage and a reduction in the noble metal content compared to the prior art.

An embodiment of the present invention is an electrode comprising an electrically conductive substrate and a catalytically active layer, wherein the catalytically active layer is based on two catalytically active components and comprises iridium, ruthenium or titanium as metal oxide or mixed oxide or mixtures of the oxides, wherein the total content of ruthenium and/or iridium based on the sum of the elements iridium, ruthenium and titanium is at least 10 mol %, and wherein the electrode comprises at least one oxidic base layer which is applied to the electrically conductive substrate and is impermeable to aqueous electrolytes comprising NaCl and/or NaOH and/or HCl.

Yet another embodiment of the present invention is an electrode comprising at least an electrically conductive substrate and a catalytically active layer, wherein the catalytically active layer is based on two catalytically active components and comprises iridium, ruthenium or titanium as metal oxide or mixed oxide or mixtures of the oxides, wherein the total content of ruthenium and/or iridium based on the sum of the elements iridium, ruthenium and titanium is at least 10 mol %, and wherein up to half of the ruthenium and/or iridium is replaced by vanadium, zirconium or molybdenum.

Yet another embodiment of the present invention is a process for producing an electrode comprising applying a sol-gel coating solution which comprises a solution or dispersion of metal compounds which comprise a metal is selected from the group consisting of ruthenium, iridium, titanium, and mixtures thereof to an electrically conductive support, drying to free solvent, calcining at a temperature of at least 350° C. in the presence of oxygen-containing gases, and optionally repeating the application of the sol-gel coating, drying, and calcining one or more times.

### BRIEF DESCRIPTION OF THE SEVERAL VIEWS OF THE DRAWING

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

FIG. 1 illustrates scanning electron micrographs of the surface of the coating from Example 6, scale: a) 10 μm.

FIG. 2 illustrates a scanning electron micrograph of the surface of the coating from Example 7, scale: 10 μm.

FIG. 3 illustrates a scanning electron micrographs of the surface of the coating from Example 8, scale: 10 μm.

FIG. 4 illustrates a scanning electron micrograph of the surface of the coating from Example 9b, scale: 10 μm.

FIG. 5 illustrates the voltammetric charge (qₐ) plotted as a function of the potential scan rate (υ) for the dense base layer (solid line) and crack structure (dotted line) from Example 9.

FIG. 6 illustrates a scanning electron micrograph of the surface of the coating from Example 10, scale: 10 μm,

FIG. 7 illustrates the voltammetric charge (q₈) plotted as a function of the number of cyclovoltammograms for the Ru_{0.4}Ti_{0.6}O₂ coating (solid line) and the Ru_{0.4}Ti_{0.45}La_{0.15}O₂ coating (dotted line) from Example 11.

FIG. 8 illustrates the voltammetric charge (qₐ) plotted as a function of the potential scan rate (υ) for the coatings from Example 12.

### DETAILED DESCRIPTION OF PREFERRED EMBODIMENTS

Certain embodiments of the invention provide a novel electrode comprising at least an electrically conductive substrate and a catalytically active coating, characterized in that the catalytically active layer is based on two catalytically active components and contains at least iridium, ruthenium or titanium as metal oxide or mixed oxide or mixtures of the oxides mentioned, where the total content of ruthenium and/or iridium based on the sum of the elements iridium, ruthenium and titanium is at least 10 mol %, preferably from 10 to 28 mol %, preferably from 10 to 20 mol %, and in that at least one oxidic base layer which is applied to the electrically conductive support and is impermeable to aqueous electrolytes comprising NaCl and/or NaOH or HCl is provided.

The electrically conductive substrate is preferably based on a valve metal, particularly preferably a metal of the group consisting of titanium, tantalum, niobium and nickel or an alloy of these metals having titanium, tantalum or niobium as main constituent.

The novel catalyst coating for the evolution of chlorine consists, for example, of an active novel metal component, preferably RuO₂ or RuO₂/IrO₂, having a content of 10-20 mol %, calculated on the basis of the total amount of metal oxide, of a component for stabilization (preferably TiO₂) and a dopant in the form of a transition metal oxide (preferably tin, lanthanum, vanadium, zirconium, chromium, molybdenum). The concentration of the dopant is in particular from 5 to 15 mol %.

Preference is given to an electrode which is characterized in that the base layer is impermeable to aqueous hydrogen chloride solution, sodium chloride solution or sodium hydroxide solution. This is the case when, for example, the cyclovoltammetric capacitive charge (qₐ) determined by integration of the anodic branch of the cyclovoltammogram in a potential scan rate range of from 5 mV/s to 200 mV/s in a cyclovoltammetric experiment (in 3.5 molar aqueous sodium chloride solution at pH=3 or in 0.5 molar hydrochloric acid, room temperature, Ag/AgCl reference electrode, scan range from 0.2 to 1.0 V (vs. Ag/AgCl)) is always less than 10 mC/cm², preferably less than 5 mC/cm² and particularly preferably less than 2 mC/cm².

Particular preference is given to an embodiment of the electrode in which a covering layer which has a cyclovoltammetric capacitive charge (qₐ) which is greater than that of the base layer is additionally provided. The cyclovoltammetric capacitive charge of the covering layer (qₐ) is preferably at least 10 mC/cm², particularly preferably 20 mC/cm².

The base layer has, in particular, a loading per unit area (as oxide) of from 0.1 to 20 g/m², preferably from 0.5 to 10 g/m², and the covering layer has, in particular, a loading per unit area (as oxide) of at least 2 g/m², preferably at least 5 g/m².

Preference is given to an electrode in which the loading (weight per unit area) of the covering layer is at least 2 g/m², preferably at least 5 g/m². A particular embodiment of the novel electrode is characterized in that the covering layer, viewed in a cross section through the layer thickness, has a changing ratio of iridium to titanium and/or ruthenium to the titanium component.

In one variation of the electrode, the ratio of iridium to titanium and/or ruthenium to titanium in the covering layer, viewed in a cross section through the layer thickness, decreases from the outside in the direction of the electrically conductive support.

As starting compound for producing the noble metal oxide and stabilization component (e.g. TiO₂) of the anode coating, preference is given to using chlorides, nitrates, alkoxides, acetylacetonates. Ruthenium acetylacetonates, iridium acetylacetonates or iridium acetates are preferably used as precursor salts for producing the noble metal component. TiO₂ can, for example, be obtained from titanium isopropoxide or titanium butoxide. The dopants are particularly preferably introduced via the precursor salts vanadium acetylacetonate, vanadium tetrabutoxide, zirconium n-propoxide, zirconium nitrate, molybdenum acetate, tin acetate, tin isopropoxide, lanthanum acetylacetonate, lanthanum nitrate.

A further embodiment of the electrode is characterized in that the covering layer comprises the components of the catalytically active layer and additionally contains pore-forming compounds, in particular compounds of lanthanum, in particular lanthanum oxide, or polymers, in particular polyvinylpyrrolidone.

In another embodiment of the electrode, the base layer is electrically conductive and has a conductivity of at least 10 S/m, preferably at least 1000 S/m, particularly preferably at least 10 000 S/m.

Apart from the electrode structure described above, we have also found a further embodiment of the electrode which is further subject matter of the invention and comprises at least an electrically conductive substrate and a catalytically active coating, characterized in that the catalytically active layer is based on two catalytically active components and contains at least iridium, ruthenium or titanium as metal oxide or mixed oxide or mixtures of the oxides mentioned, where the total content of ruthenium and/or iridium based on the sum of the elements iridium, ruthenium and titanium is at least 10 mol %, preferably from 10 to 28 mol %, preferably from 10 to 20 mol %, and in that up to half of the ruthenium and/or iridium is replaced by vanadium, zirconium or molybdenum, preferably by vanadium.

This selected structure can preferably be combined with the subject matter of the electrode described first so as to provide, in addition, an oxidic base layer which is applied to the electrically conductive support and is impermeable to aqueous electrolytes comprising NaCl and/or NaOH or HCl.

Embodiments of the invention further provide a process for producing an electrode, in particular a novel electrode as described above, characterized in that a sol-gel coating solution containing a solution or dispersion of metal compounds of one or more of the metals: ruthenium, iridium and titanium is, in a first step, applied one or more times to an electrically conductive support, in particular by means of dipping, and is then freed of solvent and the dried metal compound layer is subsequently calcined at elevated temperature, in particular at least 350° C., preferably at least 400° C., in the presence of oxygen-containing gases and the steps: application of the solution or dispersion, drying and calcination are optionally repeated one or more times.

Preference is given to a process in which, to produce a covering layer, a solution or dispersion of metal salts of the metals of the group consisting of ruthenium, iridium and titanium is applied one or more times to the base layer, freed of solvent and calcined at elevated temperature, in particular at least 350° C., preferably at least 450° C., in the presence of oxygen-containing gases.

In an embodiment of the process, drying is carried out at elevated temperature, in particular at least 200° C., preferably at least 240° C., after application of the metal salt solution to produce the base layer.

In an variant of the method, a lower carboxylic acid, in particular propionic acid, C₁-C₅-alcohols or ketones or mixtures thereof is/or are added to the metal compound solutions for producing the base layer and/or the covering layer.

To produce a homogeneous and stable coating solution, the propionic acid-sol-gel process is particularly preferably employed. Here, a mixture of propionic acid with alcohols (methanol, ethanol, n-propanol, isopropanol, butanol) in various concentrations serves as solvent for the abovementioned compounds. Dissolution of the precursor salts occurs, separately for each precursor salt, at a temperature above 130° C. with stirring. The duration of the dissolution process is about 1 hour. This results in a transparent and stable sol solution. The use of propionic acid leads to complexation of the metal cations used and thus makes controlled hydrolysis possible.

After cooling, the solutions on the individual precursor salts are mixed and subsequently stirred. The coating solution for producing electrocatalytically active chlorine evolution anodes is formed from this mixture. This coating solution can be applied to substrates such as titanium sheets or titanium meshes (e.g. expanded titanium metal). Before application, the substrates have to be mechanically, chemically or electrochemically cleaned, polished and roughened. This gives improved adhesion of the coating.

Compared to the conventional thermal salt decomposition, the sol-gel method has the following advantages:

low process temperature

mixed oxides having a controlled stoichiometry can easily be prepared by mixing sols of different compounds

high product homogeneity because mixing of the starting materials occurs on a molecular level

a high product purity results from the complete removal of simple organic radicals by means of a final heat treatment

influence can be exerted on the microstructure (porosity) of the resulting layer by means of the final thermal treatment

coating of complex geometries by dipcoating, spray coating or spincoating processes.

The sol-gel process makes it possible to produce coating solutions comprising one or more readily hydrolysable alkoxides, acetylacetonates or inorganic salts which are dissolved in a solvent (methanol, ethanol, isopropanol, butanol). To produce stable colloids (sols), the solution is hydrolyzed with acid catalysis (hydrochloric, nitric or acetic acid) or base catalysis (ammonia, sodium hydroxide solution). The hydrolysis forms a network of hydroxy- and oxo-bridged metal atoms.

Substrates can then be coated with this coating solution. In the subsequent drying process, the sol is fixed to the substrate. In a final sintering step, the organic constituents are removed and the mixed oxide crystallizes in nanostructured particles. A dopant can also be introduced by means of the sol-gel technique. These dopants can increase the activity of the catalyst and thus make it possible to reduce the noble metal content.

The application of the coating solution can be carried out by means of dipping, painting, dripping, spray or spin processes. The layer is subsequently dried, in particular at room temperature, and then sintered at, for example, 250° C. for at least 10 minutes and then at 450° C. for at least 5 minutes. The final sintering step to stabilize the layer is carried out, for example, at 450° C. for from 12 to 30 minutes. To achieve improved oxidation of the components, pure oxygen or an oxygen-enriched atmosphere can be used. The layer thickness can be varied by a differing sequential repetition of the process described. Multilayers can also be obtained by means of this procedure.

Embodiments of the invention further provide an electrolyser for the electrolysis of solutions containing sodium chloride or hydrogen chloride, characterized in that a novel electrode as described above is provided as anode of the electrolyser.

Further embodiments of the invention also provide for the use of the above-described novel electrode as anode in electrolysers for the electrolysis of sodium chloride or hydrogen chloride for the electrochemical production of chlorine.

All the references described above are incorporated by reference in their entireties for all useful purposes.

As used herein, the singular terms “a” and “the” are synonymous and used interchangeably with “one or more” and “at least one,” unless the language and/or context cleary indicates otherwise. Accordingly, for example, reference to “a catalytically active component” herein or in the appended claims can refer to a single catalytically active component or more than one catalytically active component. Additionally, all numerical values, unless otherwise specifically noted, are understood to be modified by the word “about.”

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

Embodiments of the invention are illustrated by the following examples and figures, which do not, however, restrict the invention in any way.

In the figures:

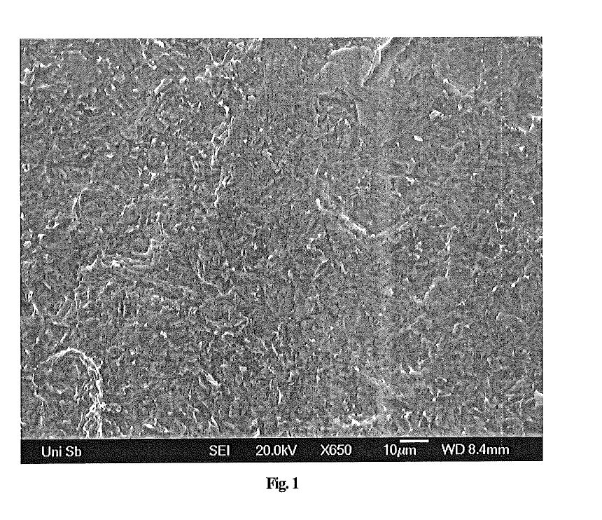

FIG. 1 shows scanning electron micrographs of the surface of the coating from Example 6, scale: a) 10 μm,

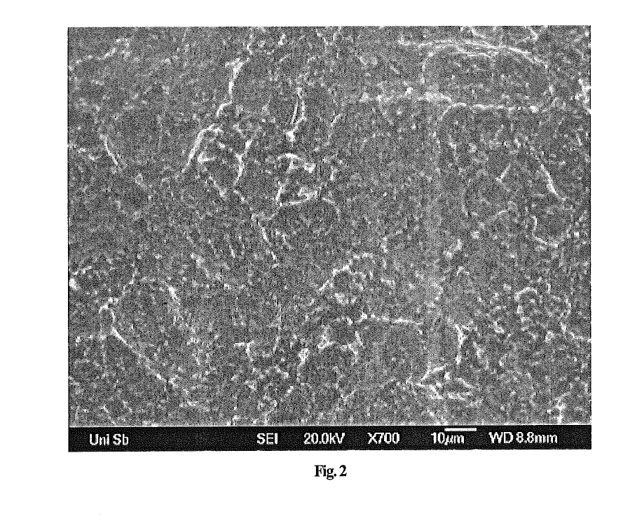

FIG. 2 shows a scanning electron micrograph of the surface of the coating from Example 7, scale: 10 μm,

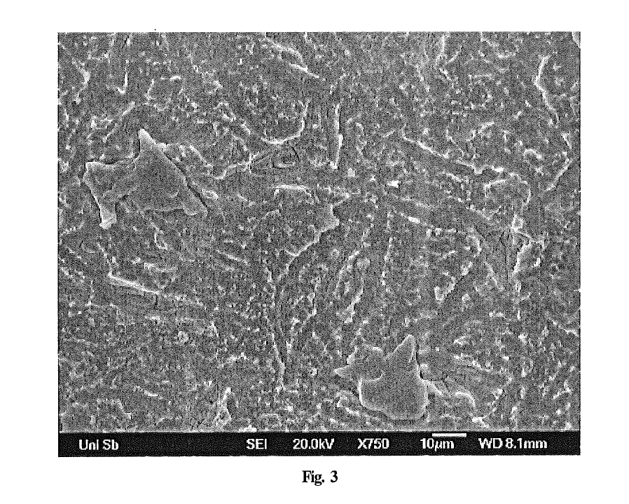

FIG. 3 shows scanning electron micrographs of the surface of the coating from Example 8, scale: 10 μm,

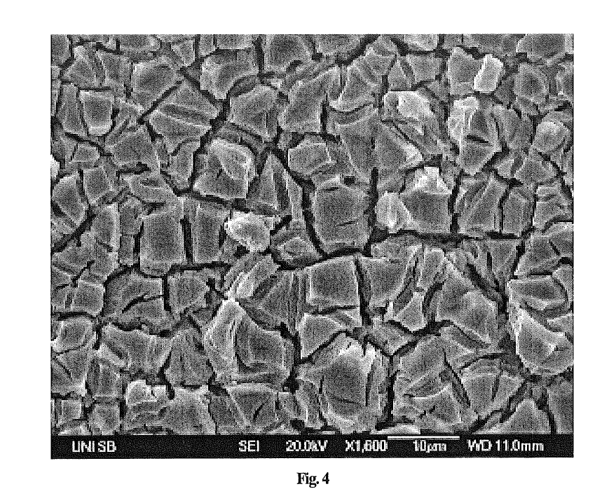

FIG. 4 shows a scanning electron micrograph of the surface of the coating from Example 9b, scale: 10 μm,

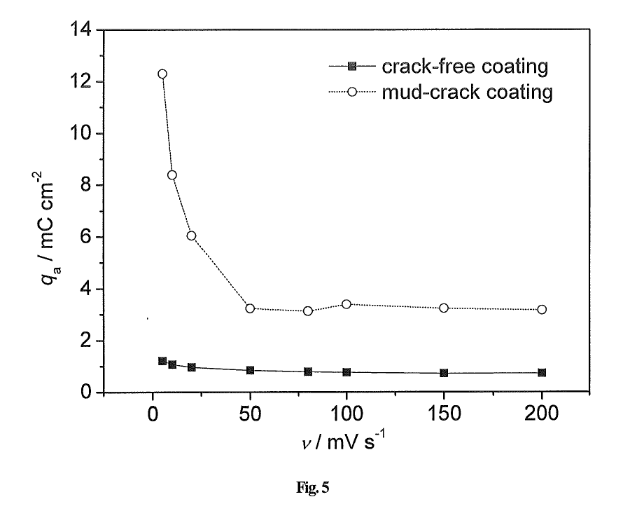

FIG. 5 shows the voltammetric charge (qₐ) plotted as a function of the potential scan rate (υ) for the dense base layer (solid line) and crack structure (dotted line) from Example 9,

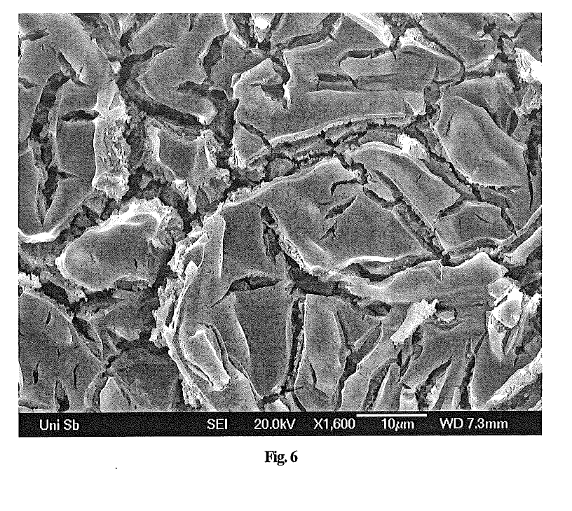

FIG. 6 shows a scanning electron micrograph of the surface of the coating from Example 10, scale: 10 μm,

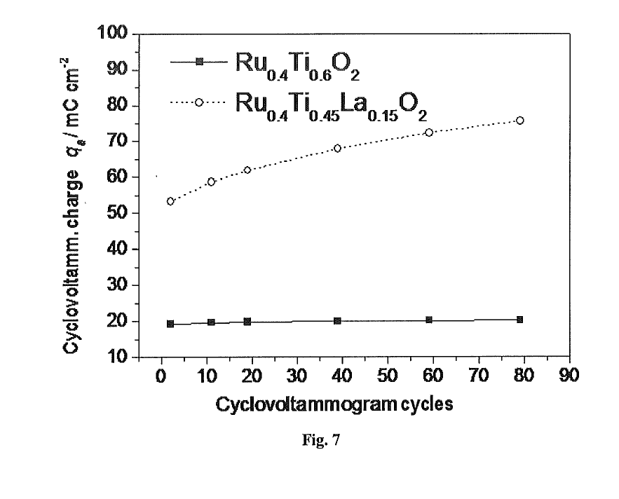

FIG. 7 shows the voltammetric charge (qₐ) plotted as a function of the number of cyclovoltammograms for the Ru_{0.4}Ti_{0.6}O₂ coating (solid line) and the Ru_{0.4}Ti_{0.45}La_{0.15}O₂ coating (dotted line) from Example 11. The cyclovoltammetry was carried out in 0.5 molar hydrochloric acid at room temperature using an Ag/AgCl reference electrode. The potential was varied in the range from 0.2 to 1.0 V (vs. Ag/AgCl) at a potential scan rate of υ=50 mV/s.

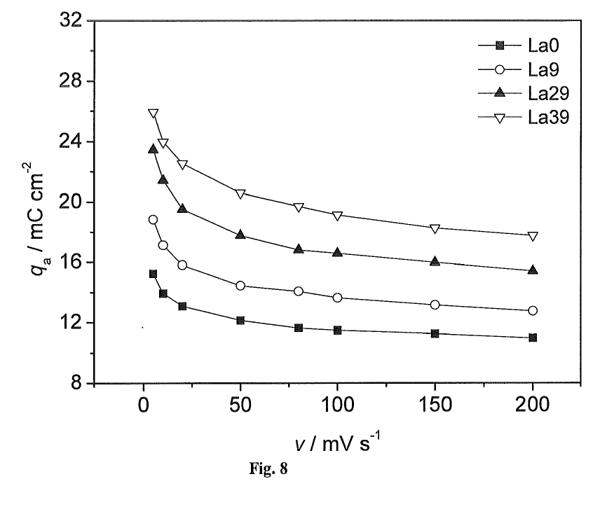

FIG. 8 shows the voltammetric charge (qₐ) plotted as a function of the potential scan rate (υ) for the coatings from Example 12. The cyclovoltammetry was carried out in 3.5 molar sodium chloride solution at room temperature using an Ag/AgCl reference electrode. The potential was varied in the range from 0.2 to 1.0 V (vs. Ag/AgCl).

### EXAMPLES

### Example 1

Titanium plates having a diameter of 15 mm (thickness 2 mm) were sand blasted to clean and to roughen the surface and subsequently pickled in 10% strength oxalic acid at 80° C. (2 hours), subsequently cleaned with isopropanol and dried in a stream of nitrogen.

To produce the coating solutions, 99.6 mg of ruthenium acetylacetonate (Ru(acac)₃), 207.2 μl of titanium isopropoxide (Ti(i-OPr)₄) and 13.3 mg of vanadyl acetylacetonate (VO(acac)₂) were each dissolved in 1.45 ml of isopropanol and 1.45 ml of propionic acid and heated under reflux for 30 minutes. After cooling to room temperature, the three solutions were mixed to give a homogeneous and transparent solution having a wine-red colour. 50 μl of this coating solution were applied by means of a micropipette to the titanium substrate and subsequently dried in air. The layer was sintered firstly for 10 minutes at 250° C. and then for 10 minutes at 450° C. in air. These procedures (application of coating solution, drying, sintering) were repeated 8 times. After the 9th coating step, the coated titanium substrate was sintered at 450° C. for 1 hour. This resulted in a sample having the composition 25 mol % of Ru/70 mol % of Ti/5 mol % V based on the metallic constituents. Calculated on the basis of the metal content, this corresponds to a ruthenium loading of 6.4 g/m². This corresponds to a total coating loading of 23.7 g/m² (as sum of the oxides RuO₂, TiO₂, V₂O₅).

The electrocatalytic activity for chlorine evolution was determined by means of chronoamperometry (reference electrode: Ag/AgCl, electrolyte: 3.5 M NaCl, pH: 3, room temperature). A steady-state current density of 1 kA/m² was set in the experiment. The resulting potential was 1.17 volt.

### Example 1b (Comparative Example)

The titanium substrates were pretreated in a manner analogous to Example 1.

To produce a coating by thermal decomposition, a coating solution containing 2.00 g of ruthenium(III) chloride hydrate (Ru content=40.5% by weight), 21.56 g of n-butanol, 0.94 g of concentrated hydrochloric acid and 5.93 g of tetrabutyl titanate Ti-(O-Bu)₄) was produced. Part of the coating solution was applied to a small titanium plate by means of a brush. This was dried at 80° C. in air for 10 minutes and subsequently treated at 470° C. in air for 10 minutes. This procedure (application of solution, drying, heat treatment) was carried out a total of 8 times. The plate was subsequently treated in air at 520° C. for 1 hour. The loading of ruthenium per unit area was calculated from the consumption of the coating solution as 16 g/m², corresponding to a total coating loading of 49.2 g/m² (as oxides) at a composition of 31 mol % of RuO₂ and 69 mol % of TiO₂.

The potential for chlorine evolution (measured in a manner analogous to Example 1) was 1.25 volt for this sample.

### Example 2

The titanium substrates were pretreated in a manner analogous to Example 1.

60 mg of ruthenium acetylacetonate (Ru(acac)₃), 236.8 μl of titanium isopropoxide (Ti(i-OPr)₄) and 13.3 mg of vanadyl acetylacetonate (VO(acac)₂) were each dissolved in 1.45 ml of isopropanol and 1.45 ml of propionic acid and subsequently heated under reflux (with stirring) at 150° C. for 30 minutes. After cooling to room temperature, the three solutions were mixed to give a homogeneous and transparent solution having a wine-red colour. Coating and sintering processes were carried out as described in Example 1.

This resulted in a sample having the composition 15 mol % of Ru/80 mol % of Ti/5 mol % of V based on the metallic constituents. Calculated on the basis of the metal content, this corresponds to a ruthenium loading of 3.9 g/m². This corresponds to a total coating loading of 22.7 g/m² (as sum of the oxides RuO₂, TiO₂, V₂O₂).

The potential for chlorine evolution (measured in a manner analogous to Example 1) was 1.17 volt for this sample.

### Example 3

The titanium substrates were pretreated in a manner analogous to Example 1.

99.6 mg of ruthenium acetylacetonate (Ru(acac)₃), 207.2 μl of titanium isopropoxide (Ti(i-OPr)₄) and 22.4 μl of zirconium n-propoxide (70% by weight in n-propanol) were each dissolved in 1.44 ml of isopropanol and 1.44 ml of propionic acid and subsequently heated under reflux (with stirring) at 150° C. for 30 minutes. After cooling to room temperature, the three solutions were mixed to give a homogeneous and transparent solution having a wine-red colour. Coating and sintering processes were carried out as described in Example 1.

This resulted in a sample having the composition 25 mol % of Ru/70 mol % of Ti/5 mol % of Zr based on the metallic constituents. Calculated on the basis of the metal content, this corresponds to a ruthenium loading of 6.4 g/m². This corresponds to a total coating loading of 24.2 g/m² (as sum of the oxides RuO₂, TiO₂, ZrO₂).

The potential for chlorine evolution (measured in a manner analogous to Example 1) was 1.25 volt for this sample.

### Example 4

The titanium substrates were pretreated in a manner analogous to Example 1.

99.6 mg of ruthenium acetylacetonate (Ru(acac)₃), 192.4 μl of titanium isopropoxide (Ti(i-OPr)₄) and 42.8 mg of molybdenum acetate (Mo₂(OCOCH₃)₄) were each dissolved in 1.45 ml of isopropanol and 1.45 ml of propionic acid and subsequently heated under reflux (with stirring) at 150° C. for 30 minutes. After cooling to room temperature, the three solutions were mixed to give a homogeneous and transparent solution having a wine-red colour. Coating and sintering processes were carried out as described in Example 1.

This resulted in a sample having the composition 25 mol % of Ru/65 mol % of Ti/10 mol % of Mo based on the metallic constituents. Calculated on the basis of the metal content, this corresponds to a ruthenium loading of 6.4 g/m². This corresponds to a total coating loading of 25,2 g/m² (as sum of the oxides RuO₂, TiO₂, MoO₃).

The potential for chlorine evolution (measured in a manner analogous to Example 1) was 1.18 volt for this sample.

### Example 5

The titanium substrates were pretreated in a manner analogous to Example 1.

49.8 mg of ruthenium acetylacetonate (Ru(acac)₃), 62.3 mg iridium acetylacetanate (Iracac)₃, 16.6 mg of vanadyl acetylacetonate (VO(acac)₂), 207.6 mg of tin isopropoxide propanol (Sn(i-OPr)₄.C₃H₇OH) and 129.5 μl of titanium isopropoxide (Ti(i-OPr)₄) were each dissolved in 1.11 ml of isopropanol and 1.11 ml of propionic acid and subsequently heated under reflux (with stirring) at 150° C. for 30 minutes. After cooling to room temperature, the five solutions were mixed to give a homogeneous and transparent solution having a wine-red colour.

Coating and sintering processes were carried out as described in Example 1.

This results in a sample having the composition 10 mol % of Ru, 10 mol % of Ir, 5 mol % of V, 40 mol % of Sn, 35 mol % of Ti based on the metallic constituents. Calculated on the basis of the metal content, this corresponds to a ruthenium loading of 3.2 g/m². This corresponds to a total coating loading of 33.6 g/m² (as sum of the oxides RuO₂, IrO₂, V₂O₅, SnO₂, TiO₂).

The potential for chlorine evolution (measured in a manner analogous to Example 1) was 1.22 volt for this sample.

### Example 6

The titanium substrates were pretreated in a manner analogous to Example 1.

149.4 mg of ruthenium acetylacetonate (Ru(acac)₃) and 333.1 μl of titanium isopropoxide (Ti(i-OPr)₄) were each dissolved in 3.25 ml of isopropanol and 3.25 ml of propionic acid and subsequently heated under reflux (with stirring) at 150° C. for 30 minutes. After cooling to room temperature, the two solutions were mixed to give a homogeneous and transparent solution having a wine-red colour.

The crack-free and dense coatings were produced by dipcoating. For this purpose, the titanium substrates were dipped into the coating solution for a time of 20 seconds and subsequently lifted out vertically from the coating solution at a speed of 167 mm per minute and subsequently dried in air. The layer was sintered firstly for 10 minutes at 250° C. and then for 5 minutes at 450° C. in air. The procedure dipcoating-drying-sintering was repeated 5 times.

This resulted in a sample having the composition 25 mol % of Ru, 75 mol % of Ti based on the metallic constituents. Calculated on the basis of the metal content, this corresponds to a ruthenium loading of 0.16 g/m². This corresponds to a total coating loading of 0.59 g/m² (as sum of the oxides RuO₂, TiO₂).

The resulting surface morphology of the coating produced was characterized by means of scanning electron microscopy, see FIG. 1.

### Example 7

The titanium substrates were pretreated in a manner analogous to Example 1.

The coating solutions are identical to Example 6.

The crack-free and dense coatings were obtained in a manner analogous to Example 6. The procedure dipcoating-drying-sintering was repeated 15 times. This resulted in a sample having the composition 25 mol % of Ru, 75 mol % of Ti based on the metallic constituents. Calculated on the basis of the metal content, this corresponds to a ruthenium loading of 0.50 g/m². This corresponds to a total coating loading of 1.84 g/m² (as sum of the oxides RuO₂, TiO₂).

The resulting surface morphology of the coating produced was characterized by means of scanning electron microscopy, see FIG. 2.

### Example 8

The titanium substrates were pretreated in a manner analogous to Example 1.

The coating solutions were obtained by dissolving 421.1 mg of ruthenium(III) chloride hydrate (RuCl₃.xH₂O, 36% Ru) in 4.62 ml of isopropanol and stirred overnight (solution A). 1332 ml of titanium isopropoxide (Ti(i-OPr)₄) were added to a premixed solution of 2.246 ml of 4-hydroxy-4-methyl-2-pentanone and 5 ml of isopropanol and stirred for 30 minutes (solution B). Solution A and solution B were mixed by means of treatment with ultrasound and a clear solution was obtained. 25.8 μl of acetic acid and 108 μl of deionized water were subsequently added to the solution. The solution produced in this way was covered and stirred overnight at room temperature.

The crack-free and dense coatings were produced by dipcoating. For this purpose, the titanium substrates were dipped into the coating solution for a time of 20 seconds and subsequently lifted out vertically from the coating solution at a speed of 193 mm per minute and subsequently dried in air. The layer was sintered firstly for 30 minutes at 90° C. and then for 10 minutes at 450° C. in air. The procedure dipcoating-drying-sintering was repeated 6 times.

This resulted in a sample having the composition 25 mol % of Ru, 75 mol % of Ti based on the metallic constituents. Calculated on the basis of the metal content, this corresponds to a ruthenium loading of 1.0 g/m². This corresponds to a total coating loading of 3.69 g/m² (as sum of the oxides RuO₂, TiO₂).

The resulting surface morphology of the coating produced was characterized by means of scanning electron microscopy, see FIG. 3.

### Example 9

The titanium substrates were pretreated in a manner analogous to Example 1.

The coating solutions were obtained by dissolving 210.6 mg of ruthenium(III) chloride hydrate (RuCl₃.xH₂O, 36% Ru) in 4.81 ml of isopropanol and stirred overnight (solution A). 666.1 ml of titanium isopropoxide (Ti(i-OPr)₄) were added to a premixed solution of 1.123 ml of 4-hydroxy-4-methyl-2-pentanone and 20 ml of isopropanol and stirred for 30 minutes (solution B). Solution A and solution B were mixed by means of treatment with ultrasound and a clear solution was obtained. 12.9 μl of acetic acid and 54 μl of deionized water were subsequently added to the solution. The solution produced in this way was covered and stirred overnight at room temperature.

The crack-free and dense coatings were produced by dipcoating. For this purpose, the titanium substrates were dipped into the coating solution for a time of 20 seconds and subsequently lifted out vertically from the coating solution at a speed of 193 mm per minute. The wet coating was dried in air and sintered for 30 minutes at 90° C. and then for 10 minutes at 450° C. in air. The procedure dipcoating-drying-sintering was repeated 50 times, with final sintering for 1 hour at 450° C.

This resulted in a sample having the composition 25 mol % of Ru, 75 mol % of Ti based on the metallic constituents. Calculated on the basis of the metal content, this corresponds to a ruthenium loading of 2.0 g/m². This corresponds to a total coating loading of 7.38 g/m² (as sum of the oxides RuO₂, TiO₂).

### Example 9b (Comparative Example)

For comparison, a coating having a mud-crack structure was produced using the same coating solutions as in Example 9.

The titanium substrates were pretreated in a manner analogous to Example 1 and 50 μl of the coating solution was applied by means of the dripping-on process using a micropipetter.

The wet coating was dried in air and sintered for 30 minutes at 90° C. and then for 10 minutes at 450° C. in air. The procedure dripping-on coating-drying-sintering was repeated 4 times, with final sintering for 1 hour at 450° C.

This resulted in a sample having the composition 25 mol % of Ru, 75 mol % of Ti based on the metallic constituents. Calculated on the basis of the metal content, this corresponds to a ruthenium loading of 3.4 g/m². This corresponds to a total coating loading of 12.54 g/m² (as sum of the oxides RuO₂, TiO₂).

The resulting surface morphology of the coating produced was characterized by means of scanning electron microscopy, see FIG. 4.

The electrodes having the crack-free structure and the mud-crack structure were examined by means of cyclovoltammetry. The measurements were carried out in 3.5 molar sodium chloride solution at pH=3 and room temperature using a silver/silver chloride reference electrode. The potential was changed in the range from 0.2 to 1.0 V at various potential scan rates (v) in the range from 5 to 200 mV/s. The voltammetric capacitive charge (qₐ) was obtained by means of EC-Lab Software by integration of the anodic branch of the cyclovoltammograms. The voltammetric charge (qₐ) is plotted as a function of the potential scan rate (v) for the crack-free coating and the coating having the mud-crack structure in FIG. 5. The voltammetric charge decreases very sharply when the potential scan rate (v) is increased from 5 to 50 mV/s and then assumes an approximately constant value for the coating having the mud-crack structure (dotted line in FIG. 5). This is in agreement with the fact that at low potential scan rates (v), penetration of the electrolyte through the cracks into the interior cracks and voids occurs and a high value for the capacitive charge is thus obtained, while at the higher potential scan rates, only the outermost surface is accessible. In contrast thereto, the capacitive charge of the crack-free coating is virtually independent of the potential scan rate (solid line in FIG. 5), which is evidence of the compact and dense character of the coating.

### Example 10

To produce a coating having a crack-free and dense base layer and a crack-containing and electrocatalytically active covering layer, the crack-free base layer was produced in a manner analogous to Example 7. This results in a sample having the base layer composition of 25 mol % of Ru, 75 mol % of Ti based on the metallic constituents. Calculated on the basis of the metal content, this corresponds to a ruthenium loading of 0.50 g/m². This corresponds to a total base layer loading of 1.84 g/m² (as sum of the oxides RuO₂, TiO₂).

The crack-containing covering layer applied to the crack-free base layer was produced using the same coating solutions as in Example 1 and the same coating and sintering procedure as in Example 1, except that a total of 4 coating-sintering cycles were carried out.

This resulted in a sample having the covering layer composition of 25 mol % of Ru/70 mol % of Ti/5 mol % of V based on the metallic constituents. Calculated on the basis of the metal content, this corresponds to a ruthenium loading of 2.6 g/m². This corresponds to a total covering layer loading of 9.64 g/m² (as sum of the oxides RuO₂, TiO₂, V₂O₅).

The resulting surface morphology of the coating produced was characterized by means of scanning electron microscopy, see FIG. 6.

The electrode potential for chlorine evolution was determined under conditions analogous to those in Example 1. The measured electrode potential was 1.21 V.

### Example 11

To produce a porous and crack-containing electrocatalytically active coating, the titanium substrates were pretreated in a manner analogous to Example 1.

The coating solutions were obtained by dissolving 67.4 mg of ruthenium(III) chloride hydrate (RuCl₃.xH₂O, 36% Ru) in 2 ml of isopropanol and stirring overnight (solution A). 39 mg of lanthanum(III) nitrate hexahydrate (La(NO₃)₃. 6H₂O) were added to 1 ml of isopropanol and stirred for 30 minutes (solution B). 80 μl of titanium isopropoxide (Ti(i-OPr)₄) were added to a premixed solution of 224.6 μl of 4-hydroxy-4-methyl-2-pentanone and 0.66 ml of isopropanol and stirred for 10 minutes (solution C).

The solutions A, B and C were mixed by means of treatment with ultrasound and a clear solution was obtained. 5.15 μl of acetic acid and 10.8 μl of deionized water were subsequently added to the solution. The solution produced in this way was covered and stirred overnight at room temperature.

50 μl of the coating solution were applied to the titanium substrate by means of the dripping-on process using a micropipetter.

The wet coating was dried in air and sintered for 10 minutes at 250° C. and then for 10 minutes at 450° C. in air. The procedure dripping-on coating-drying-sintering was repeated 5 times, with final sintering for 1 hour at 450° C.

This resulted in a sample having the composition 40 mol % of Ru/45 mol % of Ti/15 mol % of La based on the metallic constituents. Calculated on the metal content, this corresponds to a ruthenium loading of 8.5 g/m². This corresponds to a total coating loading of 29.0 g/m² (as sum of the oxides RuO₂, TiO₂, La₂O₃).

For comparison, a coating having the composition Ru_{0.4}Ti_{0.6}O₂ was produced. For this purpose, 67.4 mg of ruthenium(III) chloride hydrate (RuCl₃.xH₂O, 36% Ru) were added to 2 ml of isopropanol and stirred overnight (solution A). 106.6 μl of titanium isopropoxide (Ti(i-OPr)₄) were added to a premixed solution of 224.6 μl of 4-hydroxy-4-methyl-2-pentanone and 1.66 ml of isopropanol and stirred for 10 minutes (solution B). Solution A and solution B were mixed by means of treatment with ultrasound and a clear solution was obtained. 5.15 μl of acetic acid and 10.8 μl of deionized water were subsequently added to the solution. The solution produced in this way was covered and stirred overnight at room temperature.

50 μl of the coating solution were applied to the titanium substrate by means of the dripping-on process using a micropipetter.

The wet coating was dried in air and sintered for 10 minutes at 250° C. and then for 10 minutes at 450° C. in air. The procedure dripping-on coating-drying-sintering was repeated 5 times, with final sintering for 1 hour at 450° C.

This resulted in a sample having the composition 40 mol % of Ru/60 mol % of Ti based on the metallic constituents. Calculated on the basis of the metal content, this corresponds to a ruthenium loading of 8.5 g/m². This corresponds to a total coating loading of 21.3 g/m² (as sum of the oxides RuO₂, TiO₂).

The cyclovoltammetry was carried out in 0.5 molar hydrochloric acid at room temperature using silver/silver chloride as reference electrode. The potential was changed in the range from 0.2 to 1.0 volt at a potential scan rate of υ=50 mV/s, with the area exposed to the electrolytes being 1 cm². The voltammetric capacitive charge (qₐ) was obtained by means of EC-Lab Software by integration of the anodic branch of the cyclovoltammograms. The voltammetric charge (qₐ) is plotted as a function of the number of cyclovoltammetry cycles for the Ru_{0.4}Ti_{0.45}La_{0.15}O₂ coating (dotted line) and Ru_{0.4}Ti_{0.6}O₂ (solid line) in FIG. 7.

The cyclovoltammetric charge qₐ of the Ru_{0.4}Ti_{0.6}O₂ coating is independent of the number of cyclovoltammetry cycles, which indicates that the character of the coating does not change. In the case of the Ru_{0.4}Ti_{0.45}La_{0.15}O₂ coating, on the other hand, a continuous increase in the voltammetric charge from the second to the 79th potential cycle was observed. This is caused by continuous dissolution of the lanthanum oxide from the oxide matrix during the cyclovoltammetry cycles accompanied by a simultaneous increase in the porosity of the coating.

### Example 12

To produce a porous and crack-containing electrocatalytically active coating, the titanium substrates were pretreated in a manner analogous to Example 1.

The four coating solutions were each obtained by dissolving 37.9 mg of ruthenium(III) chloride hydrate (RuCl₃.xH₂O, 36% Ru) in 1.33 ml of isopropanol and stirring overnight (solution A). The four solutions B were each obtained by adding 130.8 mg of tin isopropoxide propanolate (Sn(i-OPr)₄.C₃H₇OH) to a mixture of 1.34 ml of isopropanol and 1.33 ml of propionic acid and subsequently boiling under reflux at 150° C. for 30 minutes with vigorous stirring. A different amount of lanthanum(III) nitrate hexahydrate (La(NO₃)₃.6H₂O), namely 39 mg, 29.2 mg, 9.7 mg and 0 mg, was subsequently added to the four hot solutions B and these solutions were then stirred for a further 20 minutes before being cooled to room temperature. These solutions were subsequently added dropwise to the solutions A while stirring.

50 μl of the coating solution were in each case applied to the titanium substrate by means of the dripping-on process using a micropipetter.

The wet coating was dried in air and sintered for 10 minutes at 250° C. and then for 10 minutes at 450° C. in air. The coated titanium plates were then dipped into 5% strength hydrochloric acid at a temperature of 60° C. for 15 minutes with gentle stirring in order to dissolve the lanthanum oxide constituents of the coatings.

The procedure dripping-on coating-drying-sintering-dissolution was repeated 8 times in each case, with final sintering at 450° C. for 1 hour.

This results in 4 samples having the composition 30 mol % of Ru/70 mol % of Sn based on the metallic constituents. Calculated on the basis of the metal content, this corresponds to a ruthenium loading of 7.7 g/m² in each case. This corresponds to a total coating loading of 36.9 g/m² in each case (as sum of the oxides RuO₂, SnO₂).

The coatings obtained were denoted by La39, La29, La9, La0, corresponding to the different amounts of lanthanum(III) nitrate hexahydrate (39 mg, 29.2 mg, 9.7 mg or 0 mg) present in the coating solution.

The electrodes were examined by means of cyclovoltammetry as described in Example 9 and the voltammetric capacitive charge (qₐ) was determined as in Example 9. The voltammetric charge (qₐ) as a function of the potential scan rate (υ) of the electrodes is shown in FIG. 8. The voltammetric charge (qₐ) decreases to an ever greater extent with increasing potential scan rate from 5 to 200 mV/s. This is a sign of the crack-containing and porous structure of the coatings. An increase in the capacitive charge with increasing lanthanum(III) nitrate hexahydrate was observed. Coatings of higher porosity are obtained as a result of the dissolution of lanthanum oxide.

### Example 13

To produce a porous and crack-containing electrocatalytically active coating, the titanium substrates were pretreated in a manner analogous to Example 1.

To produce the coating solutions, 99.6 mg of ruthenium acetylacetonate (Ru(acac)₃), 192.4 μl of titanium isopropoxide (Ti(i-OPr)₄) and 26.6 mg of vanadyl acetylacetonate (VO(acac)₂) were each dissolved in 1.45 ml of isopropanol and 1.45 ml of propionic acid and in each case heated under reflux at 150° C. for 30 minutes with vigorous stirring. After cooling to room temperature, the three solutions were mixed and a homogeneous and transparent solution having a wine-red colour was obtained. 72.2 mg of polyvinylpyrrolidone K30 (PVP) (average molecular weight Mw=40 000) were added to the solution and the solution was treated with ultrasound for 30 minutes. 50 μl of this coating solution were dripped onto the titanium substrate by means of a micropipette and subsequently dried in air. The layer was sintered firstly for 15 minutes at 250° C. and then for 20 minutes at 450° C. in air. These procedures (application of coating solution, drying, sintering) were repeated 8 times. The coated titanium substrate was subsequently sintered at 450° C. for 1 hour.

This resulted in a sample having the composition 25 mol % of Ru, 65 mol % of Ti and 10 mol % of V based on the metallic constituents. Calculated on the basis of the metal content, this corresponds to a ruthenium loading of 6.4 g/m². This corresponds to a total coating loading of 23.9 g/m² (as sum of the oxides RuO₂, TiO₂ and V₂O₅).

The cyclovoltammetry was carried out in 3.5 molar sodium chloride solution at room temperature using an Ag/AgCl reference electrode. The potential was varied in the range from 0.2 to 1.0 V (vs. Ag/AgCl) at a potential scan rate of υ=50 mV/s. The voltammetric capacitive charge (qₐ) was determined as in Example 9. A value of 39.2 mC/cm² was obtained for the porous and crack-containing layer.

For comparison, an electrode was produced using the same coating solution but without the addition of polyvinylpyrrolidone (PVP) according to an otherwise identical production procedure and the voltammetric capacitive charge (qₐ) was determined in the same way. A value of 20.8 mC/cm² was obtained for the voltammetric capacitive charge (qₐ) of the coating without addition of PVP.

1. An electrode comprising
an electrically conductive substrate and
a catalytically active layer,
wherein the catalytically active layer is based on two catalytically active components and comprises iridium, ruthenium or titanium as metal oxide or mixed oxide or mixtures of the oxides,
wherein the total content of ruthenium and/or iridium based on the sum of the elements iridium, ruthenium and titanium is at least 10 mol %, and
wherein the electrode comprises at least one oxidic base layer which is applied to the electrically conductive substrate and is impermeable to aqueous electrolytes comprising NaCl and/or NaOH and/or HCl.

2. The electrode according to claim 1, wherein the electrically conductive substrate is based on a valve metal.

3. The electrode according to claim 2, wherein the valve metal is selected from the group consisting of titanium, tantalum, niobium, nickel, an alloy of any of these metals having titanium, tantalum or niobium as main constituent, and mixtures thereof.

4. The electrode according to claim 1, wherein the at least one oxidic base layer is impermeable to aqueous hydrogen chloride solution, sodium chloride solution and sodium hydroxide solution.

5. The electrode according to claim 1, wherein the electrode further comprises a covering layer whose cyclovoltammetric charge is greater than that of the base layer.

6. The electrode according to claim 5, wherein the covering layer comprises the components of the catalytically active layer and additionally comprises pore-forming compounds.

7. The electrode according to claim 6, wherein the pore-forming compounds comprises a lanthanum oxide, a polymer, or mixtures thereof.

8. The electrode according to claim 1, wherein the at least one oxidic base layer thickness (loading per unit area as oxide) is from 0.1 to 20 g/m².

9. The electrode according to claim 1, wherein the covering layer thickness (loading per unit area as oxide) is at least 2 g/m².

10. The electrode according to claim 1, wherein the covering layer, viewed in a cross section through the layer thickness, has a changing ratio of iridium to titanium and/or ruthenium to titanium component.

11. The electrode according to claim 10, wherein the ratio of iridium to titanium and/or ruthenium to titanium in the covering layer, viewed in a cross section through the layer thickness, decreases from the outside in the direction of the electrically conductive support.

12. The electrode according to claim 1, wherein the at least one oxidic base layer is electrically conductive and has a conductivity of at least 10 S/m.

13. An electrode comprising
at least an electrically conductive substrate and
a catalytically active layer,
wherein the catalytically active layer is based on two catalytically active components and comprises iridium, ruthenium or titanium as metal oxide or mixed oxide or mixtures of the oxides,
wherein the total content of ruthenium and/or iridium based on the sum of the elements iridium, ruthenium and titanium is at least 10 mol %, and wherein up to half of the ruthenium and/or iridium is replaced by vanadium, zirconium or molybdenum.

14. The electrode according to claim 13, wherein the electrode comprises at least one oxidic base layer which is applied to the electrically conductive substrate and is impermeable to aqueous electrolytes comprising NaCl and/or NaOH and/or HCl.

15. A process for producing an electrode comprising
applying a sol-gel coating solution which comprises a solution or dispersion of metal compounds which comprise a metal is selected from the group consisting of ruthenium, iridium, titanium, and mixtures thereof to an electrically conductive support,
drying to free solvent,
calcining at a temperature of at least 350° C. in the presence of oxygen-containing gases and
optionally repeating the application of the sol-gel coating, drying, and calcining one or more times.

16. The process according to claim 15, further comprising
applying a covering layer, which is obtained by
applying a solution or dispersion of metal salts of the metals selected from the group consisting of ruthenium, iridium, titanium, and mixtures thereof one or more times to a base layer,
drying to free solvent and
calcining at a temperature of at least 350° C. in the presence of oxygen-containing gases.

17. The process according to claim 15, wherein drying is carried out at elevated temperature, in particular at least 200° C., preferably at least 240° C., after application of the metal salt solution to produce the base layer.

18. The process according to claim 16, wherein a lower carboxylic acid, C₁-C₅-alcohols, ketones or mixtures thereof is/are added to the metal compound solutions or dispersions for producing the base layer and/or the covering layer.

19. An electrolyser for the electrolysis of solutions containing sodium chloride or hydrogen chloride comprising an electrode according to claim 1 as an anode.

20. A process for the electrochemical production of chlorine comprising electrolyzing sodium chloride or hydrogen chloride in an electrolyser comprising the electrode according to claim 1.
